(19) United States
(12) Patent Application Publication
(10) Pub. No.: US 2006/0082989 A1
(43) Pub. Date: Apr. 20, 2006

(54) Asymmetric LED in-ground lamp

(75) Inventor: Yung-Hong Wang, Taipei Hsien (TW)

Correspondence Address: DENNISON, SCHULTZ, DOUGHERTY & MACDONALD, 1727 KING STREET, SUITE 105, ALEXANDRIA, VA, 22314, US

(73) Assignee: YEONG LONG ELECTRIC INDUSTRY CO., LTD.

(21) Appl. No.: 10/965,862

(22) Filed: Oct. 18, 2004

(51) Int. Cl. F21S 8/00

(52) U.S. Cl. 362/153

(57) ABSTRACT

An Asymmetric LED In-Ground lamp comprises a number of LED arrays and a number of arrays of LED combined with lens, wherein said LED arrays and said arrays of LED combined with lens are in an asymmetric alternative arrangement with each other in a manner that lights from both arrays can irradiate alternatively over a wall face, and a more uniform and wider irradiation area can be obtained by overlapping the feature of the wider irradiation area exhibited by the LED array itself with the feature of the more concentrated irradiation and higher candel exhibited by the array of LED combined with lens.

### FIELD OF THE INVENTION

The invention relates to an asymmetric LED In-ground lamp, and in particular, to an innovative structure to utilize special optical characteristics of high power LED to achieve high system efficacy of an up-light wash application, and to provide comparable illumination and better illumination area than those of existing lighting system with much less energy.

### BACKGROUND OF THE INVENTION

A conventional in-ground lamp as shown in FIG. 6A consists essentially of a halogen light source with surrounding fixture enclosure to protect the light source 9, It exhibits its lighting function by irradiating luminous flux coming out from the light source upwardly through the protection glass of a fixture enclosure 9 buried under the ground.

Though the halogen ground lamp 9 has a good lighting effect, its light source for illuminating is rather concentrated and with symmetric luminous distribution to the extent that only a local area is illuminated. And with symmetric nature of the light source, much of the luminous output of the light source, hence energy is not utilized. Not only does this arrangement wastes much energy with the light ray partially trapped inside the fixture and partially spilled over to un-intended projection area, often it generates undesired spilled luminance causing environmental light pollution. By way of example, as the halogen ground lamp 9 illuminates successively from an angle of elevation of from 0 degree to 180 degrees, and from an angle of elevation of from 90 degrees to 270 degrees on a wall face 8, a polar plot as shown in FIG. 6B can be seen from this halogen ground lamp 9. It is evident from FIG. 6B that the candel from the halogen ground lamp 9 is distributed only over a narrow area, such that it is not suitable for illuminating over large area and only applicable for focused illuminating. Further, a halogen ground lamp 9 can generate extensive heat itself such that, when buried underground, it may cause burn accident. Moreover, the service life of the lamp is short and hence need frequent maintenance.

In view of the foregoing, a conventional ground lamp exhibits still many disadvantages to be improved. Based on the above-described disadvantages, the inventor had studied extensively for a long period and carried out practical tests, and found finally that those disadvantages associated with the prior art can be overcome and an optimum ground lamp can be obtained by employing a combined LED arrangements and an asymmetric angular distribution.

### SUMMARY OF THE INVENTION

Accordingly, one object of the invention is to provide an Asymmetric LED In-Ground lamp characterized in that it has a uniform and wide illumination area by an LED array in conjunction with array of LED combined with lenses.

Another object of the invention is to provide an Asymmetric LED In-Ground lamp with safety and a long service life.

The Asymmetric LED In-Ground lamp according to the invention comprises a number of groups of LED arrays and arrays of LEDs combined with lenses, wherein said LED arrays and arrays of LED combined with lenses are in an asymmetric arrangement with each other in a manner that light from both of them will irradiate alternatively on a target and a more uniform and wider irradiated area can be obtained by overlapping the feature of the wide irradiation area exhibited by the LED array itself with the feature of more concentrated irradiation and higher candel exhibited by the array of LED combined with lense.

### BRIEF DESCRIPTION OF THE DRAWING

The present invention may best be understood through the following description with reference to the accompanying drawings, in which:

FIG. 1A is a schematic view showing the structure of the LED ground lamp according to the invention;

FIG. 1B is a schematic outside view of the LED ground lamp according to the invention;

FIG. 1C is a schematic view showing the arrangement of LED ground lamps according to the invention;

FIG. 2A is a schematic view showing light-emitting angles of the LED ground lamps according to the invention;

FIG. 2B is a graph showing the candel distribution of LED ground lamps shown in FIG. 2A;

FIG. 3A is a schematic view showing light-emitting angles of LEDs combined with lenses according to the invention;

FIG. 3B is a graph showing the candel distribution of LEDs combined with lenses shown in FIG. 3A;

FIG. 4A is a schematic view showing the angle of the asymmetric LED according to the invention;

FIG. 4B is a graph showing the candel distribution when the angle C in FIG. 4A is 57 degrees;

FIG. 4C is a graph showing the candel distribution when the angle B in FIG. 4A is 47 degrees;

FIG. 4D is a graph showing the candel distribution when the angle A in FIG. 4A is 72 degrees;

FIG. 5A is a schematic view showing the installation of LED ground lamps in an embodiment of the present invention;

FIG. 5B is a light distribution curve of FIG. 5A;

FIG. 6A is a schematic view showing the installation of conventional halogen ground lamps; and

FIG. 6B is a light distribution curve of FIG. 6A.

### SYMBOLS OF MAIN ELEMENTS

1 LED orientation module
2 Receptive chamber
3 Protective cover
4 Transparent cover
5 LED array
6 array of LED combined with lens
7 LED ground lamp
8 Wall face
9 Halogen ground lamp

### DETAILED DESCRIPTION OF THE PREFERRED EMBODIMENTS

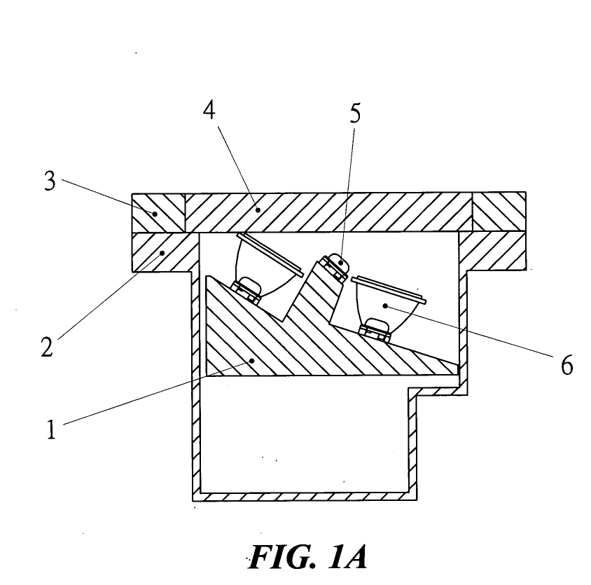

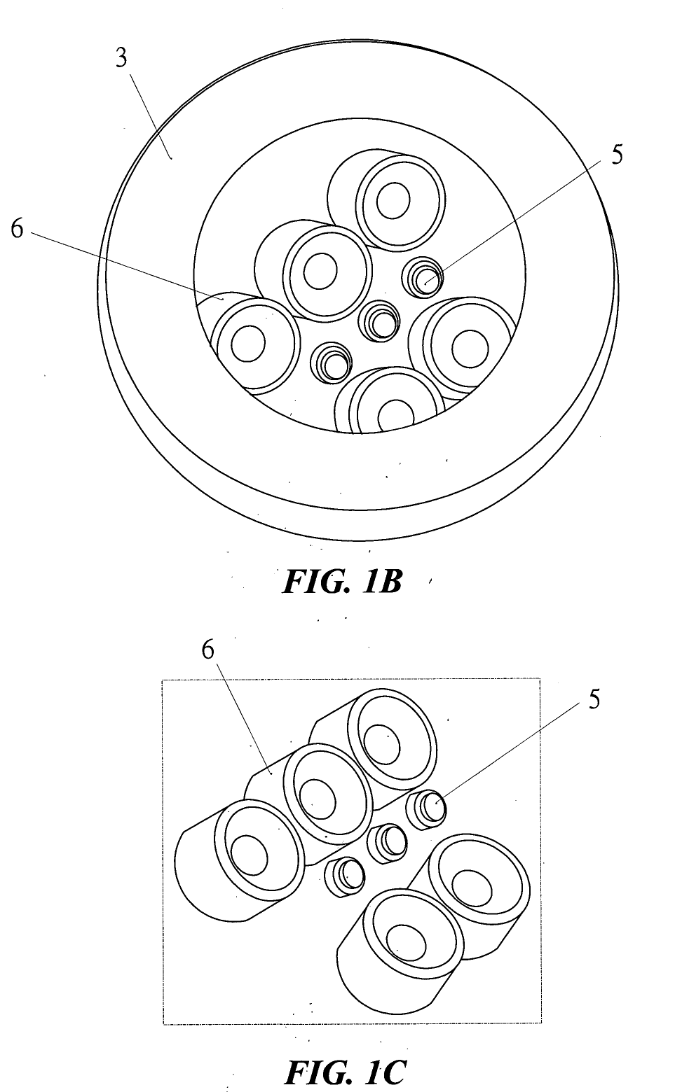

Referring to FIG. 1A to 1C, the Asymmetric LED In-Ground lamp comprises mainly a number of arrays formed from LED 5, and a number of arrays formed from LED combined with lens 6, wherein said LED array 5 and said array of LED combined with lens 6 are constructed on a LED orientation module 1 which is installed in a receptive chamber 2; wherein said receptive chamber 2 is provided on its upper opening with a protective cover 3; and wherein said protective cover 3 is provided at its inside with a transparent cover 4 for light transmitting therethrough.

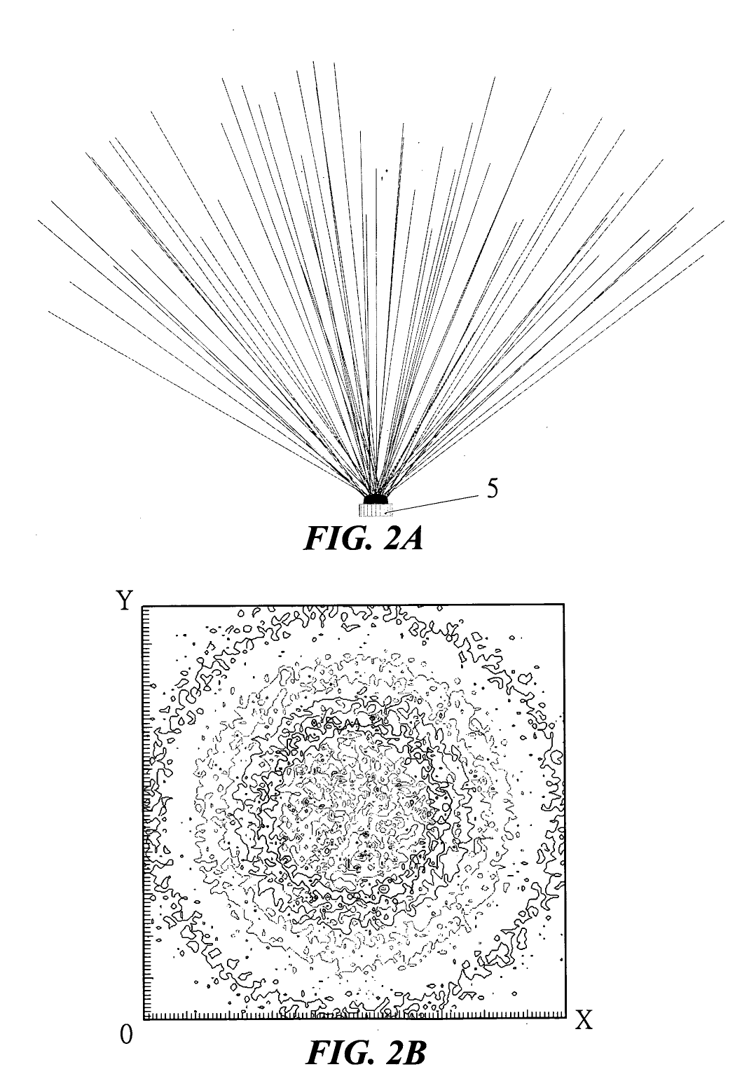

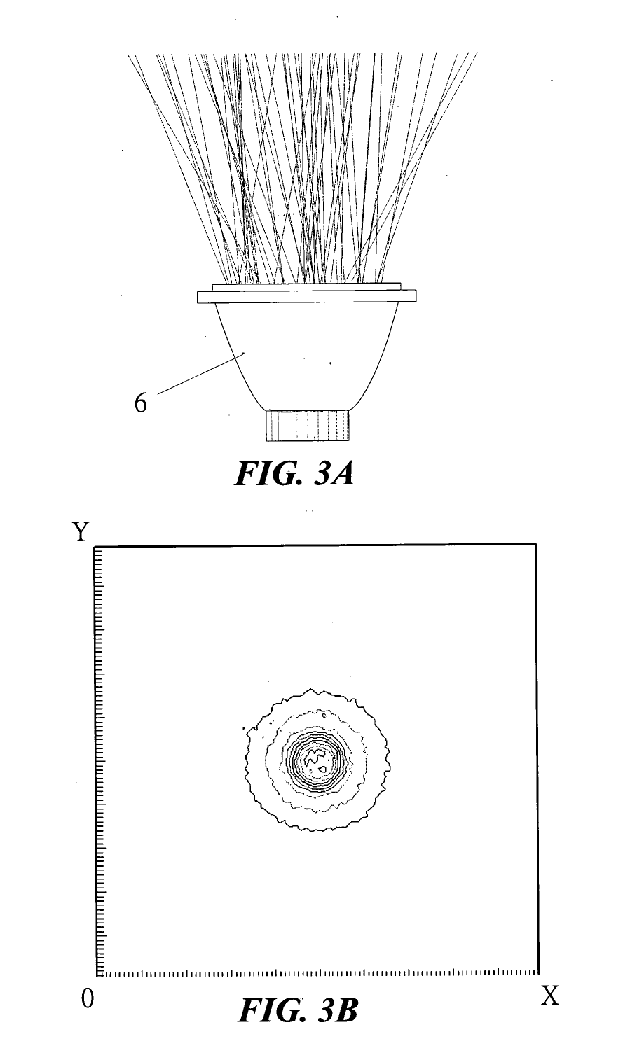

Referring to FIG. 2A, a pure LED 5 exhibits a larger light irradiation area with a candel distribution as shown in FIG. 2B, where each annular curve represents a different candel range and hence indicates the light irradiation area of the pure LED 5. As shown in FIG. 3A, a LED combined with a lens 6 can concentrate light to give the irradiation light a higher candel but correspondingly a less distribution area, as shown in FIG. 3B. In view of these, the Asymmetric LED In-Ground lamp according to the invention disposes alternatively a number of LEDs 5 with a number of LEDs combined with lenses 6, and adjust them into an appropriate relative angles in a manner that advantages of both can be functioned together and thereby obtain a uniform and wide irradiation area.

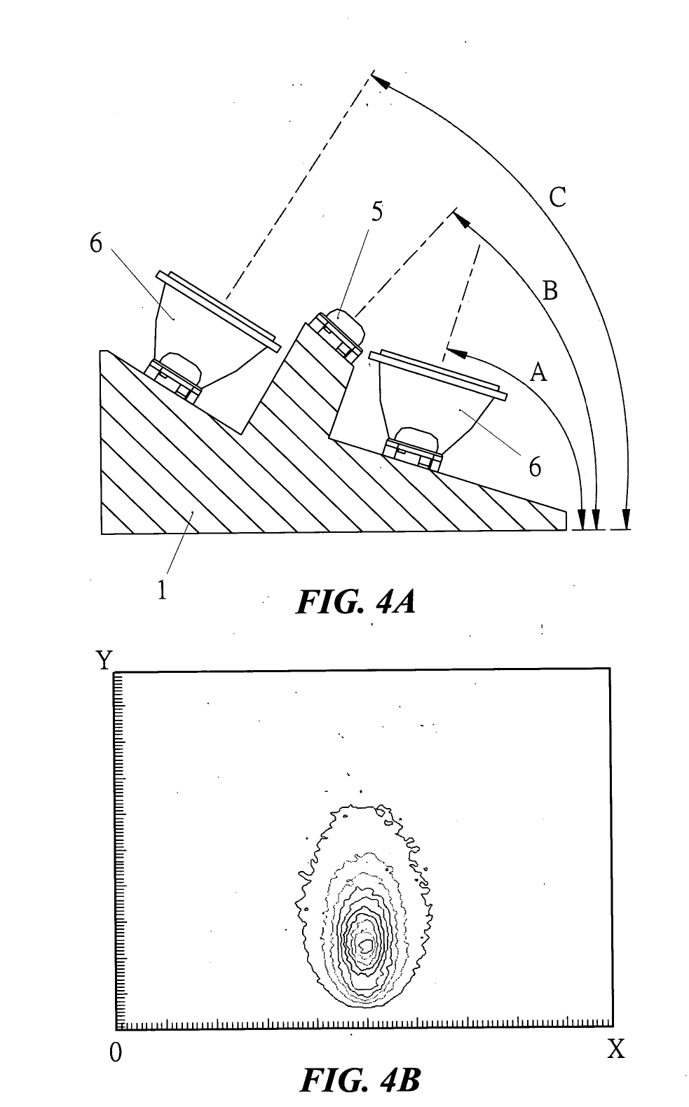

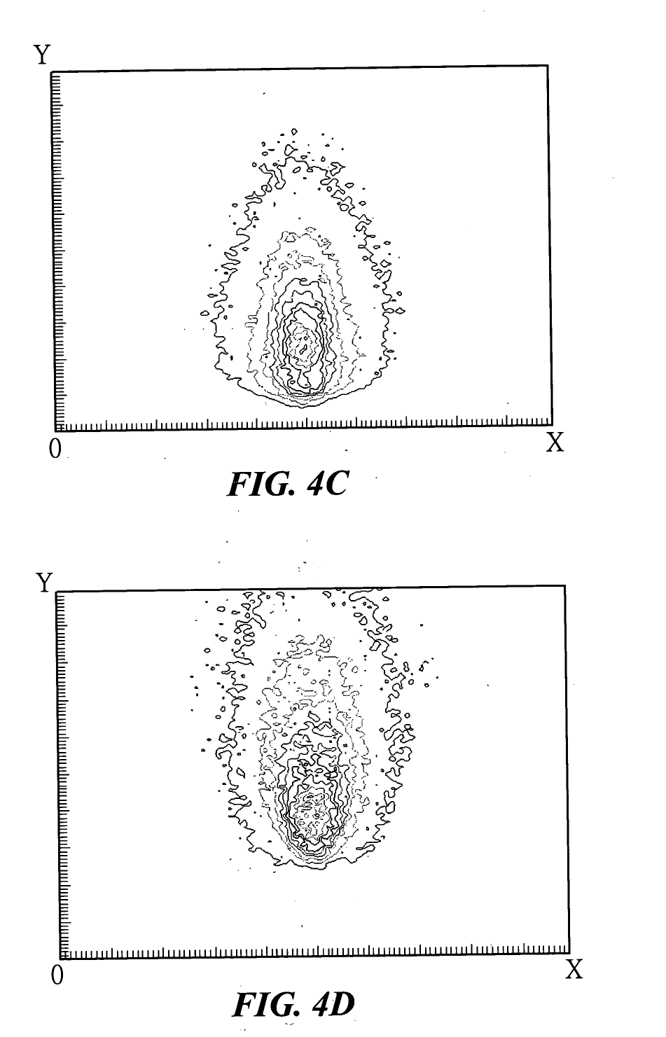

Referring to FIG. 4A, the Asymmetric LED In-Ground lamp according to the invention arranges a number of LEDs 5 and a number of LEDs combined with lenses 6 with one another in different angles. Since arrays of LED 5 exhibit a characteristic of lower candel but larger irradiation area, arrays of LED 5 are disposed at upper position of the LED orientation module 1, that is, a position more projective toward irradiation direction. Under such situation, light irradiated from arrays of LEDs 5 will not be shielded by light from arrays of LEDs combined with lenses 6 and hence a wider available irradiation area can be obtained.

The irradiation area can be adjusted as desired with respect to the different arranging angle between arrays of LEDs 5 and arrays of LEDs combined with lenses 6. For example, as the array of LED 6 on the upper position is modified downwardly to 57 degrees, the resulting overall candel distribution curve turns to be one shown in FIG. 4B, that is, in a lower position. Alternatively, as the lower arrays of LEDs combined with lenses 6 is adjusted upwardly to an angle A of 72 degrees, a candel distribution is resulted as shown in FIG. 4D, that is, a distribution deviating to the upper part. Further, when the array of LED 5 is adjusted to a moderate angle B of 47 degrees, its candel distribution becomes that shown in FIG. 4C, a more moderate distribution. Ranges of adjustable angles in the above-mentioned LED arrays are as follow:
Angle A=65 degrees to 77 degrees
Angle B=30 degrees to 60 degrees
Angle C=52 degrees to 70 degrees.

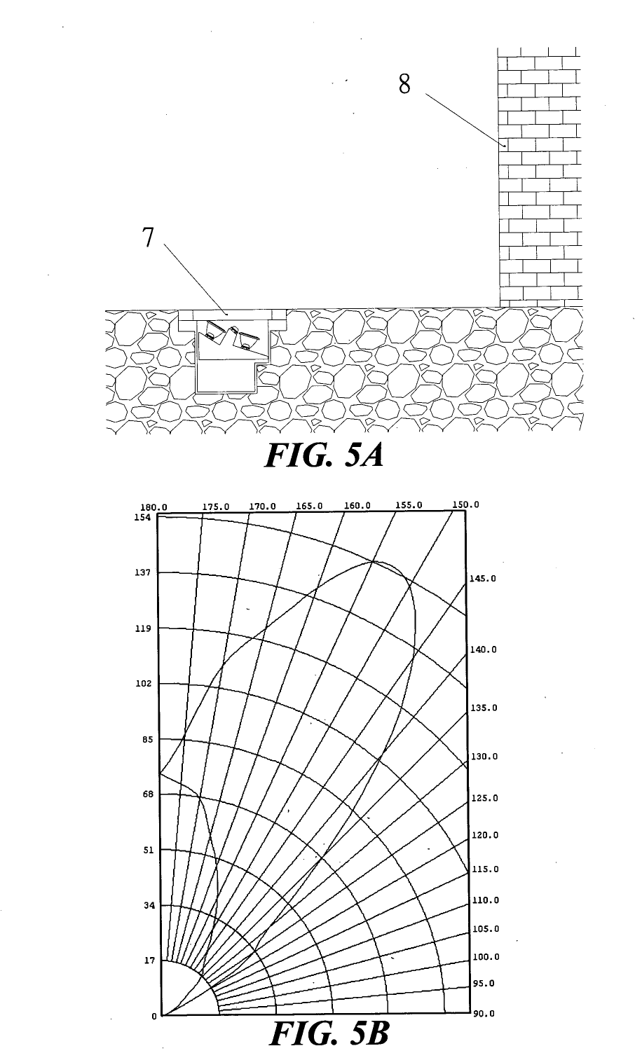

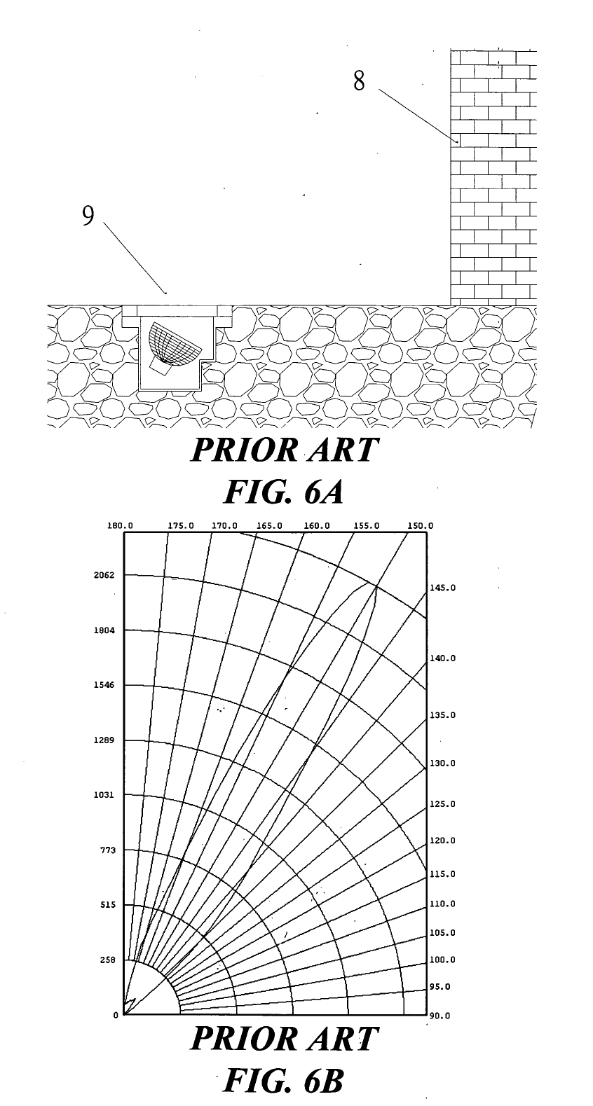

Of course, by virtue of effects of the light-emitting intensity of LED 5 and LED combined with lens 6 themselves, the thickness of the lens, the ground angle of lens and the like, the light-emitting effect of the LED ground lamp can be modified as well. Referring to FIG. 5A, the LED ground lamp 7 according to the invention is buried in the ground surface and irradiates light on a wall face 8, thereby compared with a conventional technique shown in FIG. 6A. As the LED ground lamp 7 irradiates on the wall face 8 successively at an angle of elevation from 0 degree to 180 degree, and at an angle of elevation from 90 degrees to 270 degrees, a candel distribution curve of the LED ground lamp 7 as shown in FIG. 5B can be obtained. It can be seen from FIG. 5B that the LED ground lamp 7 can yield a candel distribution with wider area, and a uniform light distribution, compared with a halogen ground lamp 9, and hence can be applied for lighting over larger area.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An Asymmetric LED In-Ground lamp, comprises:
a LED array, exhibiting larger irradiation area; and
an array of LED combined with lens, exhibiting an irradiation effect of more concentration and higher candel;
wherein said LED array and said array of LED combined with lens are installed in an asymmetric arrangement in a manner that light emitted from both arrays can irradiated on a target alternatively to yield a more uniform and wide irradiation area.

2. An Asymmetric LED In-Ground lamp as in claim 1, wherein the asymmetric angle between said LED array and said array of LED combined with lens is adjusted in accordance with the desired candel and irradiation area.

3. An Asymmetric LED In-Ground lamp as in claim 1, wherein the candel and irradiation area of said array of LED combined with lens is adjusted by virtue of the thickness and ground angle of the lens.

4. An Asymmetric LED In-Ground lamp as in claim 1, wherein one or more of said LED array and said array of LED combined with lens can be provided as desired.

5. An Asymmetric LED In-Ground lamp as in claim 1, wherein said LED array is installed more projective toward irradiation direction than said array of LED combined with lens.
